(19) United States
(12) Patent Application Publication
(10) Pub. No.: US 2013/0036884 A1
(43) Pub. Date: Feb. 14, 2013

(54) METHOD AND APPARATUS FOR PUNCHING OR PERFORATING MOVING MATERIAL WEBS

(71) Applicants: Thomas SCHURCH, Rothrist (CH); André MEZNARIC, Bern (CH)

(72) Inventors: Thomas SCHURCH, Rothrist (CH); André MEZNARIC, Bern (CH)

(73) Assignee: HUNKELER AG, Wikon (CH)

(21) Appl. No.: 13/369,611

(22) Filed: Feb. 9, 2012

(30) Foreign Application Priority Data
Feb. 10, 2011 (EP) 11001072.5

(51) Int. Cl. B26D 1/40; B26D 7/26; B26D 5/00

(52) U.S. Cl. 83/37; 83/311; 83/303; 83/285

(57) ABSTRACT

In order to make holes with different spacings between them, a punching tool is provided with punching dies on its circumference and interacts with an impression cylinder. Between two punching operations, either of the punching dies and the impression cylinder is driven, at times, at a circumferential speed that is greater or smaller than the movement speed of the material web that is to be punched or is stopped briefly and, until the next punching operation, brought once again to a circumferential speed that corresponds to the movement speed of the material web that is to be punched.

### BACKGROUND

Exemplary embodiments relate to a method and an apparatus for punching or perforating moving material webs.

DE 103 14 959 A1 discloses a punching unit which has a plurality of punching tools which are mounted on an axial element, can have the spacing between them adjusted and are intended to interact with an impression cylinder. Each punching tool has a cylindrical disk, on the circumference of which a metal band provided with punching profilings is retained in a releasable manner.

DE 298 05 004 U1 discloses another embodiment of a punching tool, which likewise has a cylindrical disk, on the circumference of which a punching plate provided with a punching profiling is retained in a releasable manner. This punching tool is provided with a device for attaching by suction, and later discharging, the punched-out parts (punchings).

### SUMMARY

Exemplary embodiments provide a method and an apparatus for punching or perforating moving material webs which makes it possible, in a straightforward manner, to alter the arrangement of the parts which are to be punched out, i.e. to alter the punching patterns.

### BRIEF DESCRIPTION OF THE DRAWINGS

Exemplary embodiments will be explained in more detail hereinbelow with reference to the figures, in which, purely schematically:

FIG. 1 shows a perspective view of a punching unit with a punching tool,

FIG. 2 shows a longitudinal section through a punching unit with two punching tools,

FIG. 3 shows a cross section of the punching unit according to FIG. 2,

FIG. 4 shows a perspective view of a punching tool,

FIG. 5 shows a perspective view of a first embodiment of a punching apparatus with two punching units,

FIG. 6 shows a perspective view of a first embodiment of a punching apparatus with three punching units,

FIG. 7 shows a perspective view of a second embodiment of a punching apparatus with two punching units,

FIG. 8 shows a perspective view of a second embodiment of a punching apparatus with three punching units,

FIG. 9 shows a perspective view, in simplified form, of the operation of punching holes in a material web,

FIG. 10 shows a side view, in simplified form, of a punching tool with the material web, which is to be processed,

FIG. 11 shows a schematic illustration of the variation of the rotational speed of the punching tool in various punching situations,

FIG. 12 shows a block diagram of the control means for a punching unit,

FIG. 13 shows a cross section of a punching unit with a first embodiment of a device for removing the punched-out parts, and

FIG. 14 shows a cross section of a punching unit with a second embodiment of a device for removing the punched-out parts.

### DETAILED DESCRIPTION OF EMBODIMENTS

If the following description of the figures and the claims refer to “punching”, this term is to be understood as both the actual punching (severing) operation and the perforating operation, in the case of which the perforated part remains temporarily connected, via weakening locations (perforations), to the material web and is detached only at a later stage.

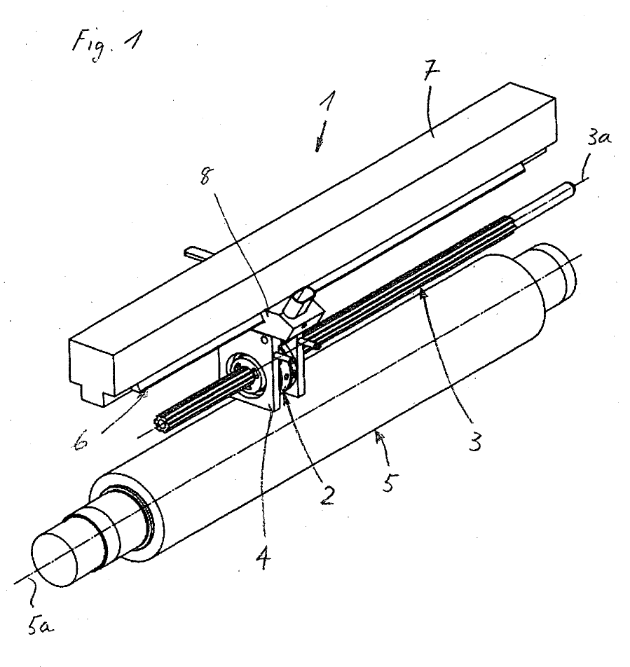

FIGS. 1 to 4 will be used to describe the construction of two different embodiments of punching unit 1 and 1′. The two embodiments differ only in that the punching unit 1 (FIG. 1) has one punching tool 2 and the punching unit 1′ has two punching tools 2, 2′, which are of the same design.

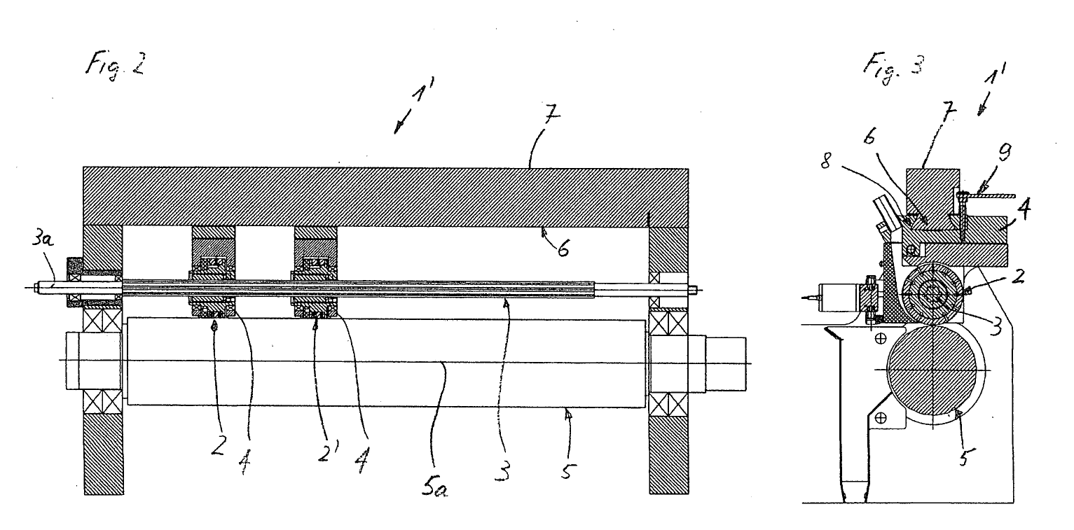

The punching tools 2 and 2, 2′ are connected in a rotationally fixed manner to a driveshaft 3, which in the case of the present exemplary embodiments is a splined shaft. The driveshaft 3 is mounted such that it can be rotated about its axis of rotation 3a, and it is connected to a drive device (not illustrated). Each punching tool 2 or 2′ is mounted such that it can be rotated in a tool holder 4, and it can be displaced therewith, in the direction of the axis of rotation 3a of the driveshaft 3, along the latter into different operating positions. The punching tools 2, 2′ interact with an impression cylinder 5, which is mounted such that it can be rotated about its axis of rotation 5a and is connected to a drive device (not illustrated). Each punching tool 2, 2′ is mounted such, e.g. using a radial coupling, that the spacing between the punching tool 2, 2′ and the impression cylinder 5 can be set individually (FIGS. 2 and 3). The impression cylinder 5 has a smooth surface, which is preferably hardened. The axis of rotation 3a of the driveshaft 3 and the axis of rotation 5a of the impression cylinder 5 run parallel to one another.

The punching tools 2, 2′ are guided by means of a guide 6 (sliding guide) that is formed on the underside of a guide bar 7 and extends over the entire operating width of the punching unit 1. This guide 6 runs parallel to the axis of rotation 5a of the impression cylinder 5. A correspondingly designed guide 8, which is formed on the tool holder 4 (see, in particular, FIG. 3), interacts with the guide 6. The tool holder 4, and with this also the punching tools 2, 2′, can be displaced along the guide 6 in a translatory manner between various operating positions. The punching tool 2, 2′ can be arrested in any operating position by way of an arresting means 9 (illustrated only schematically—FIG. 3). It is thus also possible, in the case of the punching unit 1′ shown in FIG. 2, to adjust, that is to say to alter, the spacing between the punching tools 2, 2′.

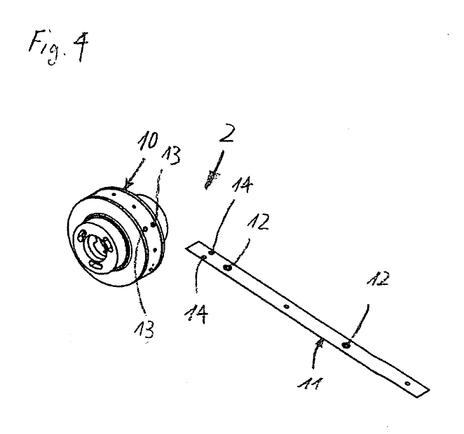

FIG. 4 shows the construction of the punching tool 2 or 2′. The punching tool 2 or 2′ has a cylindrical basic body 10, on the circumference of which a punching band 11 is retained in a releasable manner. The punching band 11 is preferably a metal band retained on the basic body 10 by means of magnetic force. The punching band 11 is provided with a number of punching dies 12, which are distributed over the length of the punching band 11. It is possible here for the spacings between the punching dies 12 to be the same or different. The punching dies 12 may be of the same shape or of different shapes (contours). Positioning pins 13 are provided on the circumference of the basic body 10, and these pins, with the punching band 11 in the mounted state, engage in positioning holes 14 in the punching band 11. The punching band 11 is positioned correctly in this way. Of course, the punching bands 11 can also be fastened in an interchangeable manner on the basic body 10 in some other suitable way. In this context, reference is made, for example, to the aforementioned DE 103 14 959 A1 and DE 298 05 004 U1. It is also conceivable for a plurality of punching bands 11 to be arranged on the circumference of the basic body 10.

It is also possible, for each punching unit 1, 1′, to provide more than two punching tools 2 on the driveshaft 3.

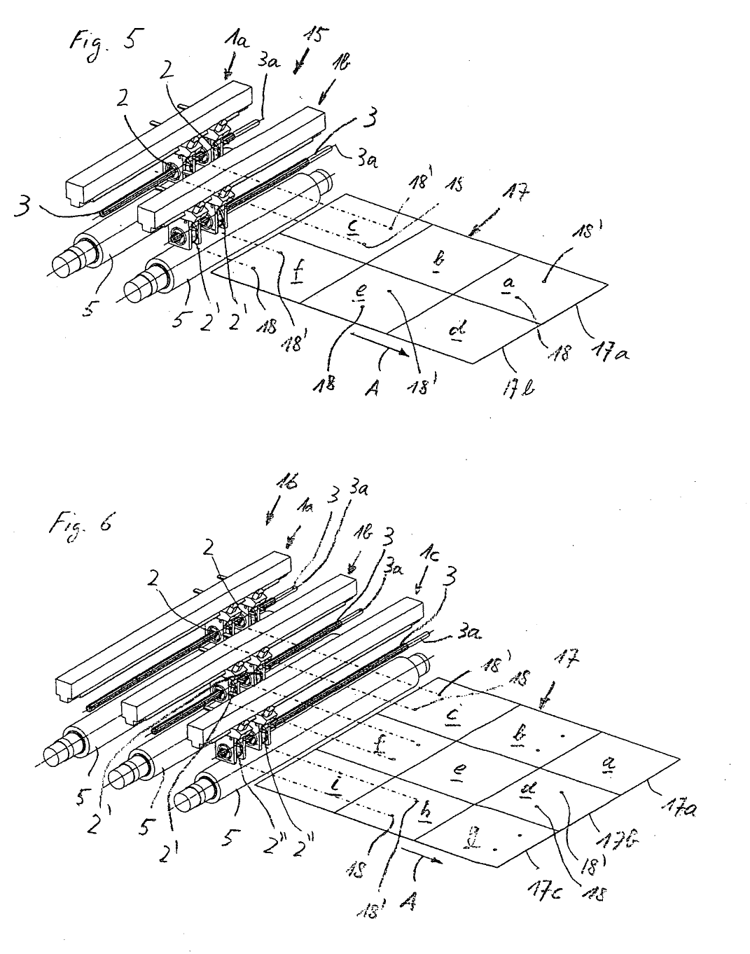

FIGS. 5 to 8 will be used to describe exemplary embodiments of punching apparatus 15 and 16 which have two punching units 1a, 1b and three punching units 1a, 1b, 1c, respectively, arranged one behind the other, as seen in the movement direction A of a material web 17 which is to be processed. The punching units 1a, 1b, 1c correspond, in terms of construction, to the punching unit 1′ shown in FIGS. 2 and 3 and each have two punching tools 4. For corresponding parts therefore, FIGS. 5 to 8 use the same designations as FIGS. 1 to 4.

The exemplary embodiments shown in FIGS. 5 and 6 differ from one another only by a different number of punching units 1a, 1b and 1a, 1b, 1c. In the case of the two exemplary embodiments, the punching tools 2 of the one punching unit 1a have been displaced in each case in relation to the punching tools 2′, 2″ of the other punching unit 1b and 1c, respectively, in the direction of the axis of rotation 3a of the driveshafts 3, that is to say therefore in a direction which runs transversely, in particular at right angles to the movement direction A of the material web 17. It is likewise the case that the punching tools 2′ of the punching unit 1b are offset in relation to the punching tools 2″ of the punching unit 1c. This means that the punching tools 2 of the punching units 1a, 1b, 1c process different regions of the material web 17.

In the case of the embodiment according to FIG. 5, the punching tools 2 of the punching unit 1a serve to punch holes 18, 18′ into the portion 17a of the material web 17, these holes serving, for example, as filing holes, whereas the tools 2′ of the second punching unit 1b punch holes 18, 18′ into the material-web portion 17b. As FIG. 5 shows, different punching operations can be carried out for the two material-web portions 17a, 17b. Thus, in the case of the material-web portion 17a, the regions a and c are provided with holes 18, 18′, whereas the region b is not punched at all. In contrast, in the case of the material-web portion 17b, the holes 18, 18′ are made in the regions e and f, whereas the region d is not punched at all.

The same applies correspondingly to the embodiment according to FIG. 6, in the case of which three portions 17a, 17b, 17c of the material web 17 can be processed differently. The tools 2 of the punching unit 1a process the material-web portion 17a, the punching tools 2′ of the punching unit 1b process the material-web portion 17b and the punching tools 2″ of the punching unit 1c process the material-web portion 17c.

As FIG. 6 shows, adjacent regions a, d, g and b, e, h and c, f, e of the material-web portions 17a, 17b, 17c are processed differently.

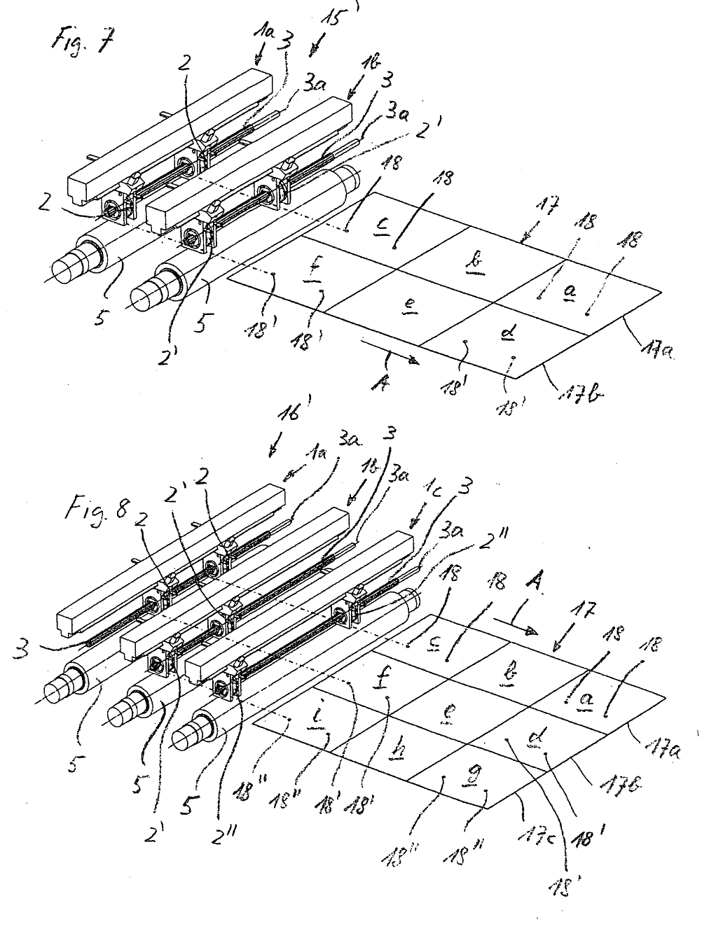

The exemplary embodiments according to FIGS. 7 and 8 also differ from one another only by a different number of punching units 1a, 1b and 1a, 1b, 1c. In the case of the two exemplary embodiments, in each case one punching tool 2, 2′, 2″ of one punching unit 1a, 1b, 1c is aligned, as seen in movement direction A of the material web 17, with a punching tool 2, 2′ or 2″ of another punching unit 1a, 1b or 1c.

In the case of the embodiment shown in FIG. 7, in each case one of the punching tools 2 of the punching unit 1a is aligned with a punching tool 2′ of the other punching unit 1b. Each pair of aligned punching tools 2, 2′ makes holes 18, 18′ in one of the two material-web portions 17a, 17b. In this case, in each case one of the two holes 18, 18′, which are made in a material-web region a, c, d and f, is punched by the punching tool 2 of the punching unit 1a and the other of the two holes 18, 18′ is punched by the punching tool 2′ of the other punching unit 1b.

In the case of the embodiment according to FIG. 8, the aligned punching tools 2, 2″ of the punching units 1a, 1c serve for punching holes 18 in the material-web portion 17a, whereas the aligned punching tools 2, 2′ of the punching units 1a, 1b serve for punching holes 18′ in the material-web portion 17b. The aligned punching tools 2′, 2″ of the punching units 1b, 1c punch out the holes 18″ in the material-web portion 17c. This makes it possible for the individual regions a, d, g and b, e, h and c, f, i of the material-web portions 17a, 17b, 17c to be processed differently from one another.

Of course, in the case of the exemplary embodiment shown in FIG. 8, it is also possible for the punching tools 2, 2′, 2″ to be aligned with one another in an arrangement other than that shown.

If, in the case of the embodiments shown in FIGS. 5 to 8, punching bands 11 with differently designed punching dies 12 are used for the punching tools 2, 2′, 2″, then punches of different contours can be produced on the material-web portions 17a, 17b, 17c.

Furthermore, it is possible for that arrangement of the punching tools 2, 2′, 2″ in relation to one another which has been explained with reference to FIGS. 5 and 6 to be combined, in the same punching apparatus, with that arrangement of the punching tools 2, 2′, 2″ in relation to one another which has been explained with reference to FIGS. 7 and 8. In the case of such a solution, some of the punching tools 2, 2′, 2″ are aligned with one another as described and some of the punching tools 2, 2′, 2″ are offset laterally in relation to one another.

Those arrangements of the punches (holes) 18, 18′, 18″ which are illustrated with reference to FIGS. 5 to 8, i.e. the punching patterns in the regions a-i of the material web 17, can be altered fairly quickly. It is thus possible to alter, for example, the spacings between the punches 18, 18′, 18″, as seen in movement direction A of the material web, and/or the number of punches 18, 18′, 18″ per material-web region a-i.

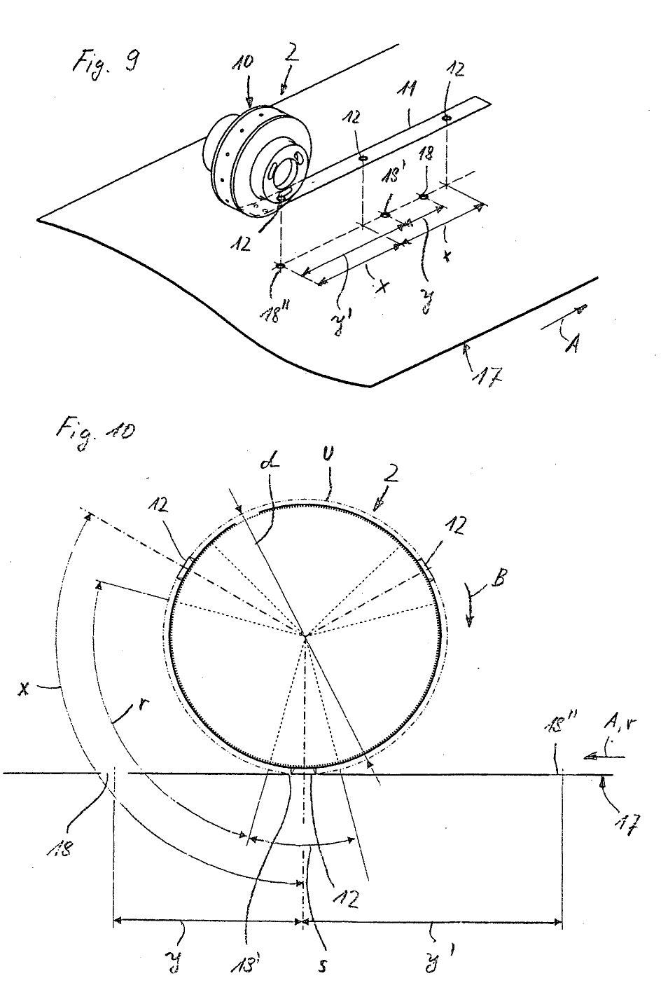

In the case of all the exemplary embodiments described, the material web 17 is moved forward in a manner that is not illustrated specifically, but is known per se, at a constant or varying speed v. The impression cylinder 5 of each punching unit 1 is driven at a circumferential speed that corresponds to the movement speed v of the material web 17. In the case of each punching unit 1, the driveshaft 3 is driven independently of the impression cylinder 5. This means that the driveshaft 3 can be driven at a rotational speed which differs from the circumferential speed of the impression cylinder 5 and thus from the movement speed v of the material web 17. This makes it possible for the punches which are to be applied to the material web 17 to be adjusted during operation, as is yet to be explained hereinbelow with reference to FIGS. 9 to 11.

The material web 17 provided with punches 18 is then processed further, and cut or folded in the longitudinal and/or transverse direction in a manner known per se.

FIGS. 9 to 11, then, will be used to describe an essential aspect of the subject matter of the invention, that is to say the possibility of punching the material web 17 with holes 18 which have a spacing between them that does not correspond to the spacing between the punching dies 12 of the punching band 11.

FIG. 9 shows, in an illustration corresponding to the illustration of FIG. 4, a punching tool 2 with an unwound punching band 11. The spacing between the punching dies 12 of the punching band 11, the spacing being uniform in the present case, is designated by x. FIG. 9 further shows a material web 17 in which holes 18, 18′, 18″ are to be punched out with spacings y and y′ between them which differ from the spacings x between the punching dies 12.

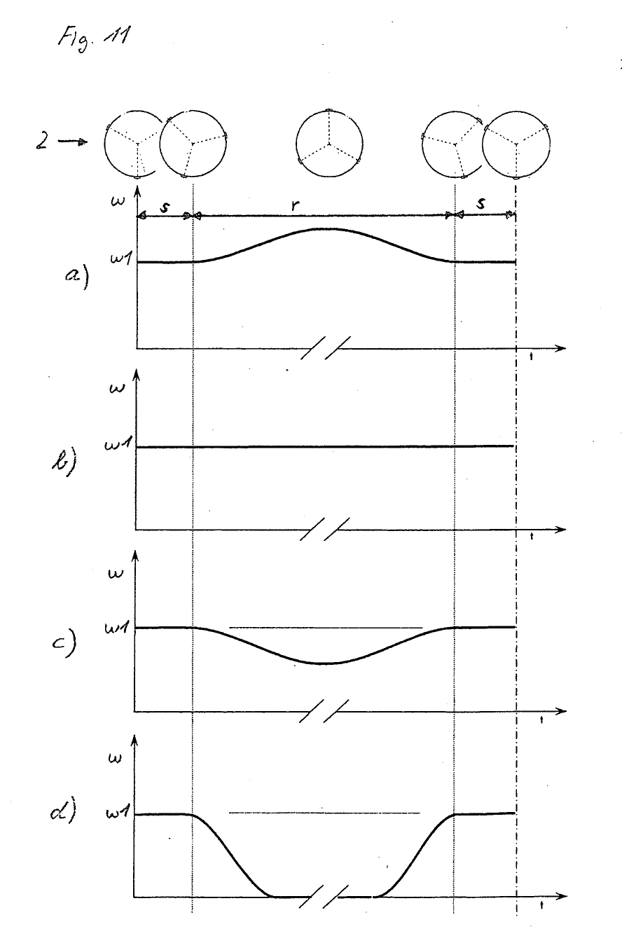

The side view of FIG. 10, which illustrates the punching tool 2 in merely quite schematic form, and also illustrates the material web 17 with the holes 18, 18′, 18″ which have been, or are to be, made, depicts the spacings x and y between the punching dies 12 and between the holes 18, 18′, 18″, respectively. In this FIG. 10, the direction of rotation (desired direction of rotation) of the punching tool 2 is designated by B and the operating diameter of the punching tool, determined by the cutting edges of the punching dies 12, is designated by d. An operating circumference U of the punching tool 2 is defined by these cutting edges of the punching tools 2 and/or by the operating diameter d. In FIG. 10, s designates an angle that defines a synchronization region. Each punching tool 12 is assigned such a synchronization region s. The angle designated by r is referred to as a dynamic region. Such a dynamic region is located between each punching die 12.

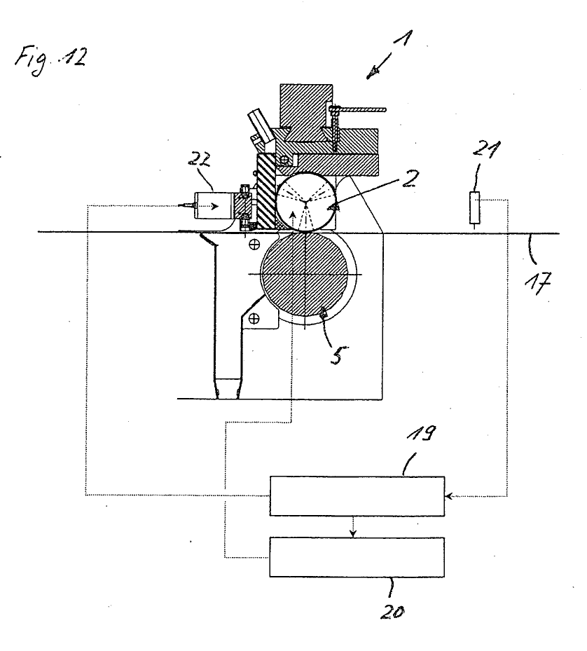

In order to punch the holes 18, 18′, 18″ with unequal spacings y, y′ between them, the punching tool 2 is driven, in the synchronization region s in each case, at a circumferential speed, on the operating circumference U, which is equal to the movement speed v of the material web 17. The operation of punching the holes 18, 18′ or 18″ then takes place in this synchronization region s. In the dynamic regions r, the circumferential speed of the punching tool 2 can be varied and correspondingly adjusted to the spacing y, y′ between the hole 18 or 18′ which has just been punched and the next hole 18′ or 18″ which is to be punched. This will be explained, then, with reference to FIG. 11.

FIGS. 11a to 11d show diagrams of different punching operations, in each of which the angular speed 107 of the punching tool 2 is plotted against the time t. These diagrams show the speed variations in two synchronization regions s, in each of which punching takes place, and in a dynamic region r located therebetween. Above the diagrams, the punching tool 2 is illustrated schematically in its various respective rotary positions. ω1 designates that angular speed of the punching tool 2 that corresponds to a circumferential speed of the punching tool 2 which corresponds with the movement speed v of the material web 17. That is to say, in the synchronization regions s, the punching tools 12 run synchronously with the material web 17. This is not the case in the dynamic region r, in which the angular speed ω of the punching tool 2 can be selected independently of the movement speed v of the material web 17, to be precise in adaptation to the ratio of the spacings y, y′ between the holes 18, 18′, 18″ to the spacing x between the punching dies 12.

The diagram of figure 11a shows the variation over time of the angular speed ω of the punching tool 2 for the situation where the spacing y, y′ between two holes 18, 18′, 18″ is smaller than the spacing x between the punching dies 12. In this case, the angular speed ω in the dynamic region r has to be increased briefly, that is to say the punching tool 2 has to be accelerated and then decelerated again to the angular speed ω1.

If the spacing y, y′ between two holes 18, 18′, 18″ is equal to the spacing x between the punching dies 12, then the punching tool 2 continues to be driven at the angular speed ω in the dynamic region r, as is illustrated in the diagram 11b. In this case, the punching tool 2 has to be neither briefly accelerated nor briefly decelerated.

The diagram of FIG. 11c shows the variation over time of the angular speed ω of the punching tool 2 for the situation where the spacing y, y′ between two holes 18, 18′, 18″ is greater than the spacing x between the punching dies 12. In this case, the angular speed ω in the dynamic region r has to be reduced briefly, that is to say the punching tool 2 has to be decelerated and then accelerated again to the angular speed ω1.

If there is no need for any holes to be made (punching to be carried out) in a region of the material web 17 (see, for example, the material-web regions b and d in FIG. 5), then the punching tool 2, following a punching operation, is stopped briefly within the subsequent dynamic region r and, prior to reaching the subsequent synchronization region s, is accelerated again to the angular speed ω1, as is illustrated in the diagram according to FIG. 11d.

In certain cases, the direction of rotation of the punching tool 2 is reversed in the dynamic region r, that is to say the punching tool 2 is rotated briefly in the rearward direction.

As described, the spacing y between two punches 18, 18′, 18″ can be influenced by controlled acceleration and/or deceleration of the punching tool 2 in the dynamic region r. This makes it possible to obtain spacings y, between the punches 18, 18′, 18″, which do not correspond to the spacings x between the punching dies 12 of the punching band 11. It is solely by altering the circumferential speed of the punching tool 2 in the dynamic region r that it is possible to produce different punching patterns without any need for mechanical adjustments.

In order for it to be possible to alter the angular speed ω of the punching tool 2, as in FIG. 11, if required such that the punches 18 are made in the material web 17 at the desired locations, the drive for the punching tool 2 has to be controlled correspondingly. FIG. 12 illustrates a block diagram of a corresponding control device. This FIG. 12 shows, in an illustration corresponding to FIG. 3, a punching unit 1, of which only the components, which are essential in conjunction with the control means, are provided with the appropriate designations.

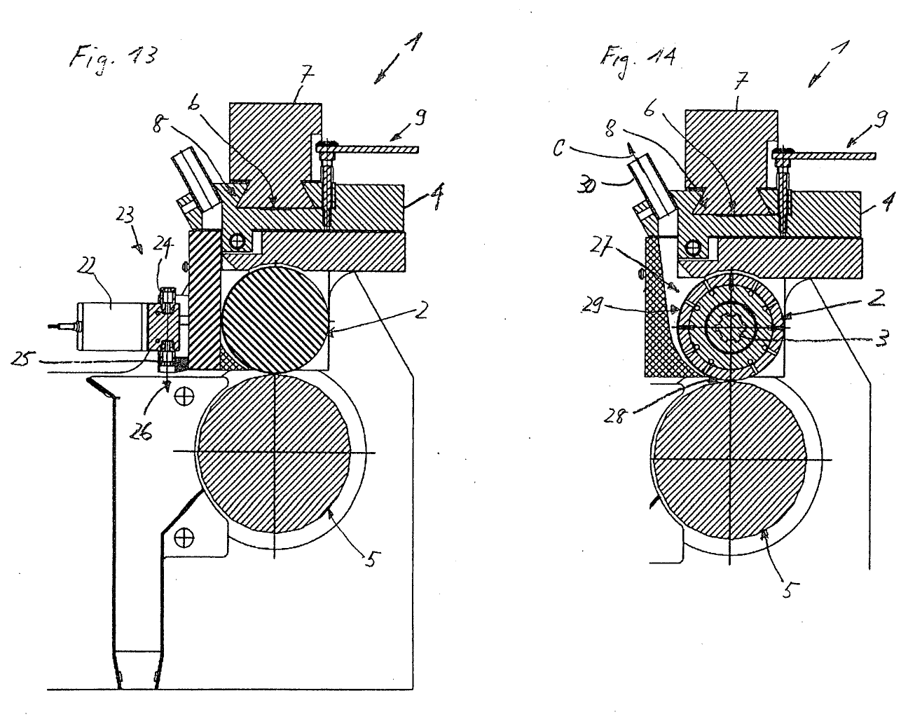

In this FIG. 12, the machine control means is designated by 19 and the control means for the drive of the driveshaft 3 of the punching tool 2 is designated by 20. The machine control means 19 is connected to a sensor 21, in the present case a contrast sensor, which senses markings on the material web 17 and feeds corresponding sensing signals to the machine control means 19. The machine control means 19 is also connected to a control valve 22 of a removal device for removing the punched-out parts (punchings), which will be explained in more detail with reference to FIG. 13, and to the drive control means 20.

The machine control means 19 stores in it the information relating to the position of the punches 18 to be made in the material web 17 and relating to the movement speed v of the material web 17. The angular speed ω1 is derived from these variables.

The sensing signals obtained by the sensor 21 and the data stored in the machine control means 19, or determined therein, are used, then, by the machine control means 19 to determine the angular speed ω at which the punching tool 2 has to be driven in the dynamic region r in order for the punching operation(s) to take place in a correctly positioned manner. In addition, the machine control means 19 activates the control valve 22 of the removal device at the correct point in time.

FIGS. 13 and 14 show sectional illustrations, corresponding to FIG. 3, of two different embodiments of removal devices for removing the punched-out parts, that is to say the punchings.

In the case of the embodiment according to FIG. 13, the punchings are released from the material web 17, and removed, by means of a timed puff of compressed air. The detached punchings can be extracted by suction or fed to a collecting container arranged beneath the material web. The removal device 23 that is used for detaching the punchings is illustrated only quite schematically and has the control valve 22 already mentioned in conjunction with FIG. 12. The inlet of the control valve 22 is connected to a compressed-air connection 26, which is connected to a compressed-air source (not illustrated). On the outlet side, the control valve 22 is connected to a blowing nozzle 25.

In the case of the control valve 22 being activated by the machine control means 19 (FIG. 12), the connection between the compressed-air connection 24 and the blowing nozzle 25 is opened briefly. This produces a puff 26 of compressed air, which blows the punching out of the material web 17. The important factor here is for the control valve 22 to be activated at the correct point in time in order that the puff 26 of compressed air is generated when the punching is located beneath the blowing nozzle 25.

In the case of the removal device 27, which is shown in FIG. 14 and is also illustrated only quite schematically, the punchings are attached to the punching tool 2 by means of negative pressure in a suction region 28, which corresponds to the synchronization region s shown in FIG. 10. As the punching tool 2 is rotated further, the punching is detached from the punching tool 2 again in a blow-out region 29 located in a dynamic region r (FIG. 10), to be precise either it is blown away by means of positive pressure and/or it is removed by means of negative pressure. The punchings detached from the punching tool 2 are removed via a suction line 30.

Of course, the removal devices 23 and 27 described may be provided both in a punching unit 1 according to FIG. 1 and in a punching unit 1′ according to FIG. 2. It is also possible, for the purpose of removing the punchings, to provide both a removal device 23 according to FIG. 13 and a removal device 27 according to FIG. 14. This means that, for one and the same punching tool 2, the punchings are removed in two different ways.

Exemplary embodiments may also include at least some or all of the following beneficial features:

A punching unit 1, as is shown in FIGS. 1 and 2 or in FIGS. 5 to 8, has at least one punching tool 2, which interacts with a rotatably mounted, drivable impression cylinder 5 and is arranged on a rotatably mounted, drivable driveshaft 3. This punching unit 1, furthermore, has a guide 6 which extends in the direction of the axis of rotation 3a of the driveshaft 3, is separate from this driveshaft 3, has the punching tool 2 guided along it for adjustment purposes and extends parallel to the longitudinal axis 5a of the impression cylinder 5.

This specific configuration of the punching unit 1, as is defined in claim 15, has the advantage that the driveshaft 3 need not perform any guidance tasks and need only be designed in order to transmit the drive power. This makes it possible to use more lightweight driveshafts 3 and thus to keep the masses which have to be accelerated or decelerated when the drive speed of the punching tools 2 is altered in the dynamic region r (FIG. 10) to as low a level as possible.

As described, use is made of a punching unit 1, 1′, or more than one punching unit 1a, 1b arranged one behind the other, of which each punching unit has one or more punching tools 2 which can be adjusted along their driveshaft 3 and can be arrested in their respective operating positions. This arrangement makes it possible straightforwardly, and fairly quickly, to change over the punching units 1 such that the arrangements of the parts that are to be punched out, that is to say the punching patterns, are different. Interchanging the punching bands 11, which is very easy to do, can alter both the punching patterns and the shape (contour) of the parts that are to be punched out.

Driving the punching tools 2 independently of the impression cylinder 5 widens the application area of the punching unit 1, as has been explained with reference to FIGS. 9 to 11.

In the case of a further embodiment, the punching tool 2 is, or the punching tools 2, 2′ are, mounted so as to be capable of movement briefly in the direction away from the impression cylinder 5. This also makes it possible to drive the punching tools 2, 2′ in the synchronization region s at a circumferential speed that differs from the circumferential speed of the impression cylinder 5 and/or from the movement speed v of the material web 17. Raising up a punching tool 2, 2′ briefly from the impression cylinder 5 and the material web 17 makes it possible, during rotation of the punching tool 2, 2′, to deactivate certain punching dies 12, i.e. for these not to be brought into contact with the material web 17 and thus for one punch 18 to be skipped. This means that the sequence of punches 18, 18′, 18″ made in the material web 17 in the movement direction A of the material web 17 differs from the sequence of punching dies 12 of the punching tool 2, 2′ in the circumferential direction of the latter.

What is claimed is:

1. A method for punching or perforating moving material webs, the method comprising:
processing the material web, that is moving at a certain movement speed, by at least one punching tool;
driving the at least one punching tool to rotate in a desired direction of rotation about an axis of rotation of the punching tool, the at least one punching tool having at least one punching die on its circumference and interacting with an impression cylinder; and
driving the impression cylinder to rotate about an axis of rotation of the impression cylinder, such that the punching tool is driven independently of the impression cylinder, and therefore the punching tool can be driven, at times, at a circumferential speed that differs from the circumferential speed of the impression cylinder and/or from the movement speed of the material web.

2. The method of claim 1, further comprising driving the impression cylinder at a circumferential speed that corresponds to the movement speed of the material web.

3. The method of claim 1, further comprising driving, at times, the punching tool, between two punching operations, at a circumferential speed that is greater or smaller than the circumferential speed of the impression cylinder and than the movement speed of the material web, respectively.

4. The method of claim 3, further comprising driving the punching tool during a punching operation, at a circumferential speed that corresponds to the movement speed of the material web.

5. The method of claim 4, further comprising altering the spacing between two punches in the material web by increasing or reducing the circumferential speed of the punching tool between two punching operations.

6. The method of claim 1, further comprising temporarily stopping the punching tool between two punching operations.

7. The method of claim 1, further comprising temporarily rotating the punching tool, between two punching operations, in a direction that is counter to the desired direction of rotation.

8. The method of claim 6, further comprising driving, during a punching operation, the punching tool at a circumferential speed that corresponds to the movement speed of the material web.

9. The method of claim 7, further comprising driving, during a punching operation, the punching tool at a circumferential speed that corresponds to the movement speed of the material web.

10. The method of claim 5, further comprising increasing or reducing the circumferential speed of the punching tool between two punching operations, including at least two punching dies that are arranged at a given spacing from one another in the circumferential direction of the punching tool, in the material web to generate punches with a spacing between them that differs from the spacing between the punching dies.

11. The method of claims 6, further comprising guiding the punching tool along a guide that extends in the direction of the axis of rotation of the punching tool, this axis of rotation being defined by a driveshaft, in which the guide is separate from the driveshaft and runs parallel to the axis of rotation of the impression cylinder.

12. The method of claim 7, further comprising guiding the punching tool along a guide that extends in the direction of the axis of rotation of the punching tool, this axis of rotation being defined by a driveshaft, in which the guide is separate from the driveshaft and runs parallel to the axis of rotation of the impression cylinder.

13. The method of claim 6, further comprising temporarily moving the punching tool in a direction away from the impression cylinder.

14. The method of claim 7, further comprising temporarily moving the punching tool in a direction away from the impression cylinder.

15. The method of claim 1, further comprising forming at least one punching die on a punching band that is fastened in an interchangeable manner on the circumference of a cylindrical basic body.

16. The method of claim 1, further comprising driving two or more punching tools to rotate synchronously with one another.

17. An apparatus for punching or perforating moving material webs, the apparatus comprising:
a rotatably mounted, drivable driveshaft having an axis of rotation;
a rotatably mounted, drivable impression cylinder having a longitudinal axis and being rotatable at a circumferential speed;
at least one punching tool that is arranged on the rotatably mounted, drivable driveshaft, the at least one punching tool having
a circumference; and
at least one punching die on its circumference and that interacts with the rotatably mounted, drivable impression cylinder,
wherein the punching tool can be driven independently of the impression cylinder, and therefore the punching tool can be driven, at times, at a circumferential speed that differs from the circumferential speed of the impression cylinder.

18. The apparatus of claim 17, further comprising a guide that is separate from and extends in the direction of the axis of rotation of the driveshaft, wherein the punching tool is guided along the guide for adjustment purposes and extends parallel to the longitudinal axis of the impression cylinder.

19. The apparatus of claim 17, further comprising two or more punching tools that are arranged on the driveshaft and can have the spacing between them adjusted.

20. The apparatus of claim 17, wherein the punching tool is configured to be stopped temporarily between two punching operations.

21. The apparatus of claim 17, wherein the punching tool, between two punching operations, is configured to rotate temporarily in a direction that is counter to a desired direction of rotation.

22. The apparatus of claim 20, further comprising a guide that is separate from and extends in the direction of the axis of rotation of the driveshaft, wherein the punching tool is guided along the guide for adjustment purposes and extends parallel to the longitudinal axis of the impression cylinder.

23. The apparatus of claim 21, further comprising a guide that is separate from and extends in the direction of the axis of rotation of the driveshaft, wherein the punching tool is guided along the guide for adjustment purposes and extends parallel to the longitudinal axis of the impression cylinder.
